(19) United States
(12) Patent Application Publication
(10) Pub. No.: US 2004/0107299 A1
(43) Pub. Date: Jun. 3, 2004

(54) Home gateway apparatus having in-home phone line switching function and embodiment method thereof

(76) Inventors: Sang-Jae Lee, Iksan-City (KR); Kwang-Roh Park, Daejeon (KR); Young-Jun Song, Cheongju (KR); Hyeong-Ho Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/441,496

(22) Filed: May 20, 2003

(30) Foreign Application Priority Data
Dec. 3, 2002 (KR) 2002-76373

(51) Int. Cl. G06F 15/16

(52) U.S. Cl. 709/249

(57) ABSTRACT

Disclosed is a home gateway apparatus having an in-home telephone network switching function, and an embodiment method thereof. The home gateway apparatus offers high-speed access to an access network using xDSL (“x” variety of Digital Subscriber Line) protocols such as ADSL or VDSL and an in-home network using VoIP (Voice over Internet Protocol) functions and a variety of protocols, and has xDSL and VoIP interfaces with PSTN (Public Switching Telephone Network) and VoIP functions that enable easy installation and application in different in-home telephone network environments. Using this, in-home VoIP/POTS (Plain Old Telephone Service) networks and high-speed HomePNA networks can be freely constructed through a single home gateway, bypassing the existing two-wire or four-wire in-home telephone lines.

### BACKGROUND OF THE INVENTION

(a) Field of the Invention

The present invention relates to a home gateway apparatus, and an embodiment method thereof. More specifically, the present invention relates to a home gateway apparatus having an in-home phone line switching function and an embodiment method thereof that provides high-speed access to an access network and an in-home network.

(b) Description of the Related Art

With the rapid development of data communication technologies in recent years, there have been ceaseless attempts made to provide more rapid and accurate information. In addition, home gateway devices have been actively developed for receiving a variety of services as the use of in-home networks connecting various appliances to communication networks at home has increased.

In general, a gateway device is a network point that plays a role as an entrance to another network, and it converts data communicated between two communication networks using different data communication protocols to a data format suitable for the individual communication networks.

Because of the development of home gateway devices in recent years, in-home networks can now be connected to external access networks to avail of a variety of services in different integrated networks.

With the recent development of the Internet, the VoIP (Voice over Internet Protocol) telephone that provides voice call services as a general telephone as well as inexpensive international telephone services at a cost of the Internet service is being watched with keen interest as a new service. For that reason, the tendency is toward the development of a home gateway device with a built-in VoIP function or an Internet phone having a VoIP function.

FIG. 1 is a schematic of a network construction according to an example of a home gateway apparatus with a VoIP function in an in-home network having an xDSL/PSTN split structure according to prior art.

Referring to FIG. 1, the conventional home gateway apparatus in an in-home network using VoIP 103 or POTS (Plain Old Telephone Service) 104 is required to have both a PSTN (Public Switched Telephone Network) interface 102 and an Internet interface 103 for the purpose of gaining access to an external PSTN and the Internet network.

In using a HomePNA (Home Phoneline Networking Alliance) function, the POTS 104 in the in-home network is also necessary. However, in the home gateway apparatus, VoIP, POTS, and HomePNA cannot be used at the same time, or a separate VoIP telephone must be connected in order to use the VoIP. Moreover, at least three separate connectors are required for the VoIP function, causing a difficulty in installation.

FIG. 2 is a diagram showing a network construction according to an example of an ADSL modem or a home gateway apparatus having a single xDSL/PSTN structure according to prior art, in which the network is comprised of a home gateway device 203 having ADSL (Asymmetric Digital Subscriber Line) and VoIP functions.

The home gateway apparatus includes, as shown in FIG. 2, a connector to an external access network providing an 8-Mbps ADSL access 201, and a connector to an in-home network providing VoIP access 206 and a network interface 207 such as a general Ethernet interface in addition to an access 202 to POTS 204 and general telephones 205.

But the conventional home gateway apparatus requires a separate telephone for the VoIP function and provides neither a PSTN interruption function nor a HomePNA function.

In addition, a variety of environments exist for the in-home network, and the conventional gateway apparatus has a difficulty in using VoIP, POTS, and HomePNA at the same time. Due to the fixed structure of the gateway apparatus, there is also a problem in that it is difficult for the gateway apparatus to match the different in-home network environments, such as two-wire or four-wire networks and a variety of users' demands for xDSL, HomePNA, VoIP, and so on.

The related technology includes Patent Application No. 10-2002-1809 by Chang-Hak Kim et al., under the title “An Internet phone gateway system with a built-in PSTN and VoIP matching circuit”, which suggests a gateway system that provides automatic origination and termination of Internet and PSTN telephone calls according to the users' demand for Internet and PSTN telephone services, and thereby guarantees inexpensive and stable call services.

However, this technology also has a limitation in that the gateway system can support the VoIP function solely in the in-home network.

### SUMMARY OF THE INVENTION

It is an advantage of the present invention to provide a home gateway apparatus having an in-home telephone network switching function and an embodiment method thereof that provides access to an access network and an in-home network, and changes the internal connection structure of the home gateway according to the construction of the in-home network by using the in-home telephone network switching function, thereby allowing easy construction of in-home VoIP/POTS and high-speed HomePNA networks without regard to the existing telephone line.

It is another advantage of the present invention to provide a home gateway apparatus having an in-home telephone network switching function and an embodiment method thereof that enables the use of a VoIP function while using the existing POTS network at home.

It is still another advantage of the present invention to provide a home gateway apparatus having an in-home telephone network switching function and an embodiment method thereof that provides both voice call and HomePNA functions through a single connector, and enables the use of a VoIP function in an in-home network only through a single four-wire xDSL connector without connecting a telephone to the home gateway.

It is still further another advantage of the present invention to provide a home gateway apparatus having an in-home telephone network switching function and an embodiment method thereof that delivers access to a variety of interface modules such as high-speed Ethernet, IEEE1394, or wireless LAN and allows the construction of a high-speed network at home.

In one aspect of the present invention, there is provided a home gateway apparatus, which provides a connection of an in-home network to an access network to offer a variety of services in an integrated network, the home gateway apparatus including: an xDSL (“x” variety of Digital Subscriber Line) central processor for providing access to the access network through a first connector, and processing a signal communicated with the connected access network; a HomePNA (Home Phoneline Networking Alliance) processor for providing HomePNA access to the in-home network through the first connector, and processing a HomePNA signal communicated with the connected in-home network; a VoIP (Voice over Internet Protocol) processor for providing a POTS (Plain Old Telephone Service)/VoIP access to the in-home network through the first connector, and processing a POTS/VoIP signal communicated with the connected in-home network; and a telephone line switching processor for connecting at least one PSTN (Public Switching Telephone Network) channel transferred from the XDSL central processor to the HomePNA processor and the VoIP processor.

In another aspect of the present invention, there is provided an embodiment method for a home gateway apparatus, which provides a connection of an in-home network to an access network to offer a variety of services in an integrated network, the embodiment method including: (a) providing access to a two-wire or four-wire access network through a first connector, and processing a signal communicated with the connected access network; (b) providing HomePNA access to the in-home network through the first connector, and processing a HomePNA signal communicated with the connected in-home network; (c) providing POTS/VoIP access to the in-home network through the first connector, and processing a POTS/VoIP signal communicated with the connected in-home network; and (d) connecting at least one PSTN channel transferred from the connected access network to a HomePNA processor processing the HomePNA signal and a VoIP processor processing the POTS/VoIP signal communicated with the connected in-home network.

In still another aspect of the present invention, there is provided a recording medium with a built-in program, which includes an embodiment method for a home gateway apparatus providing a connection of an in-home network to an access network to offer a variety of services in an integrated network, the program including: providing access to the access network through a first connector, and processing a signal communicated with the connected access network; providing HomePNA access to the in-home network through the first connector, and processing a HomePNA signal communicated with the connected in-home network; providing POTS/VoIP access to the in-home network through the first connector, and processing a POTS/VoIP signal communicated with the connected in-home network; and connecting at least one PSTN channel transferred from the connected access network to a HomePNA processor processing the HomePNA signal and a VoIP processor processing the POTS/VoIP signal communicated with the connected in-home network.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of an in-home network having an xDSL/PSTN split-type structure according to prior art;

FIG. 2 is a schematic of an in-home network having a single xDSL/PSTN structure according to prior art;

FIG. 3 is a detailed diagram showing the internal construction of a home gateway apparatus according to an embodiment of the present invention;

FIG. 4 is a detailed diagram showing the internal construction of the telephone line switch shown in FIG. 3;

FIG. 5 is a schematic of a split-type two-wire in-home network using the home gateway apparatus according to a first embodiment of the present invention;

FIG. 6 is a schematic of a non-split-type two-wire in-home network using the home gateway apparatus according to a second embodiment of the present invention;

FIG. 7 is a schematic of a four-wire in-home network having a single xDSL/PSTN structure using the home gateway apparatus according to a third embodiment of the present invention; and

FIG. 8 is a schematic of an xDSL/PSTN split-type four-wire in-home network using the home gateway apparatus according to a fourth embodiment of the present invention.

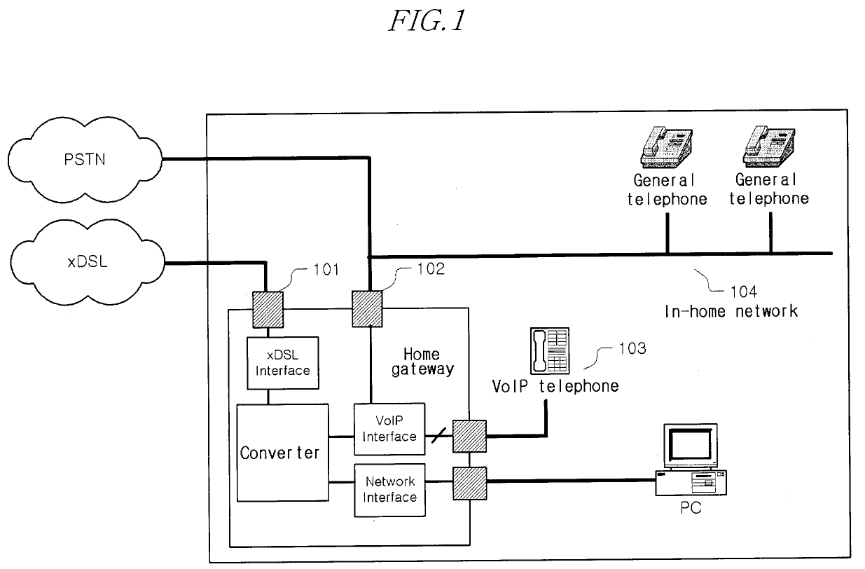

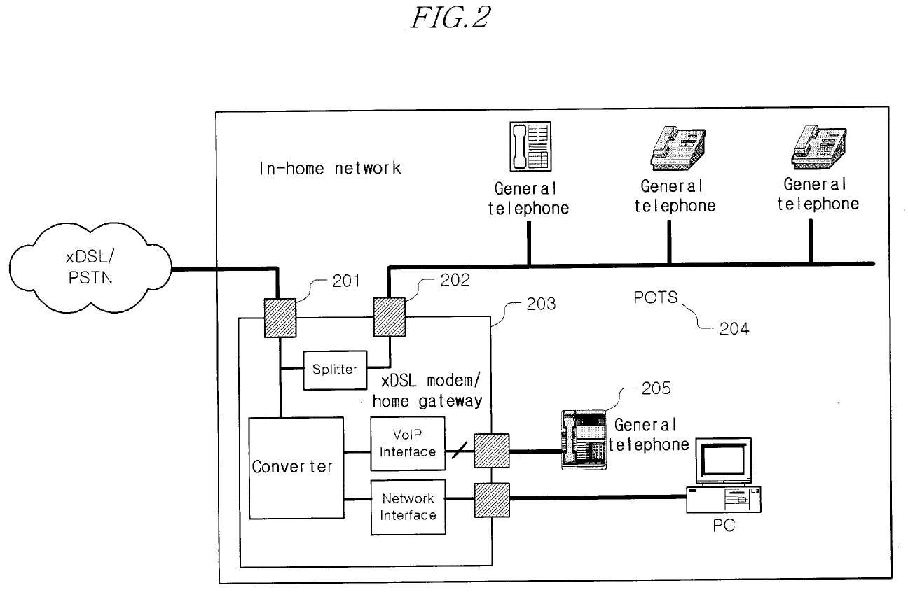

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

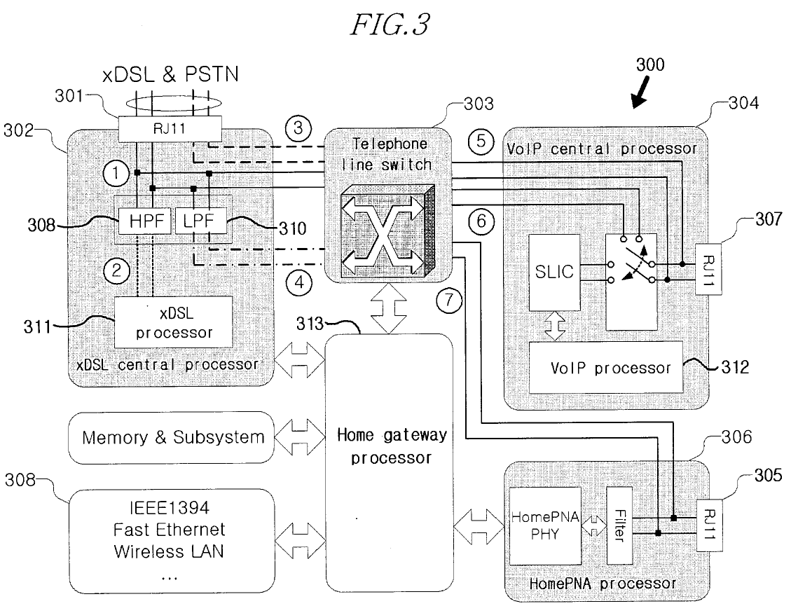

FIG. 3 is a detailed diagram showing the internal construction of a home gateway apparatus according to an embodiment of the present invention. In the embodiment of the present invention, known functions and components deviating from the scope of the present invention will not be described.

The home gateway apparatus according to the embodiment of the present invention comprises, as shown in FIG. 3, a first connector 301, an xDSL central processor 302, a telephone line switch 303, a VoIP central processor 304, a second connector 305, a HomePNA processor 306, a third connector 307, an IEEE1394 308, a high-pass filter 309, a low-pass filter 310, an xDSL processor 311, a VoIP processor 312, and a home gateway processor 313.

Although the description will be given as to the home gateway apparatus of the above construction in the embodiment of the present invention, the present invention is not specifically limited to the above construction and may further include other components.

Hereinafter, among the components of the home gateway apparatus 300, the principal components for the in-home telephone network function will be primarily described in the present invention.

First, the XDSL central processor 302 provides access to an access network through the first connector 301 providing a four-wire access with one port, and processes signals communicated with the connected access network.

The VoIP processor 304 provides POTS/VoIP access to an in-home network through the first or third connector 301 or 307, and processes POTS/VoIP signals with the connected in-home network.

The HomePNA processor 306 provides HomePNA access to the in-home network through the first or second connector 301 or 305, and processes HomePNA signals communicated with the connected in-home network.

The telephone line switch 303 connects a variety of PSTN channels received from the xDSL central processor 302 to the HomePNA processor 306 and the VoIP processor 304.

Namely, the home gateway apparatus according to the embodiment of the present invention includes the single first connector 301 for an access network connection to provide a two-wire or four-wire access to the xDSL/PSTN network, and to the telephone line switch 303 for in-home network access. The telephone line switch 303 provides a VoIP function while using the existing POTS network without a change, offers a general telephone function through a PSTN network using a general telephone in the in-home network when the home gateway apparatus 300 is in a power-off state due to service interruption, and connects a HomePNA function to the POTS/VoIP function of voice call and the xDSL function at the same time.

In particular, the xDSL central processor 302 sends xDSL and PSTN signals received through the first connector 301 to the telephone line switch 303, separates the xDSL and PSTN signals using the high-pass filter 309 and the low-pass filter 310 during transmission, and forwards them to the xDSL processor 311 and the telephone line switch 303, respectively.

The home gateway apparatus according to the embodiment of the present invention also includes the second and third connectors 305 and 307 as auxiliary connectors so that if needed, the user can connect the second and third connectors 305 and 307 directly to the home gateway apparatus without a separate network construction. The VoIP central processor 304 switches the PSTN signal received from the telephone line switch 303 using a separate switching module, so that the user can alternatively use either the PSTN function or the VoIP function.

In this manner, the home gateway apparatus according to the embodiment of the present invention provides a two-wire or four-wire XDSL, i.e., 15 ADSLNDSL access, using the single first connector 301 according to the in-home network construction as access to an access network; and access to an in-home network using a VoIP function or a variety of protocols to process POTS/VoIP/HomePNA functions using the single first connector 301 or the auxiliary second and third connectors 305 and 307.

Namely, the home gateway apparatus provides the XDSL interface and the VoIP and HomePNA interfaces by various topologies and thereby sequentially operates the access network and the in-home telephone network to offer ultrahigh-speed broadband services and VoIP services between the two networks.

FIG. 4 is a detailed diagram showing the internal construction of the telephone line switch 303 shown in FIG. 3.

As shown in FIG. 4, the telephone line switch 303 connects the PSTN signal lines received from the xDSL central processor 302 to the VoIP central processor 304 and the HomePNA processor 306. The switching functions can be enabled using a separate relay according to the user's desired setting of switches, or initially by using a jumper line according to the in-home environment during installation of the home gateway apparatus.

When the in-home network environment changes, the in-home network can be constructed simply by changing the setting of the telephone line switch 303 without replacement of the home gateway.

Now, first to fourth embodiments using the home gateway apparatus of the present invention will be described in detail with reference to the accompanying drawings.

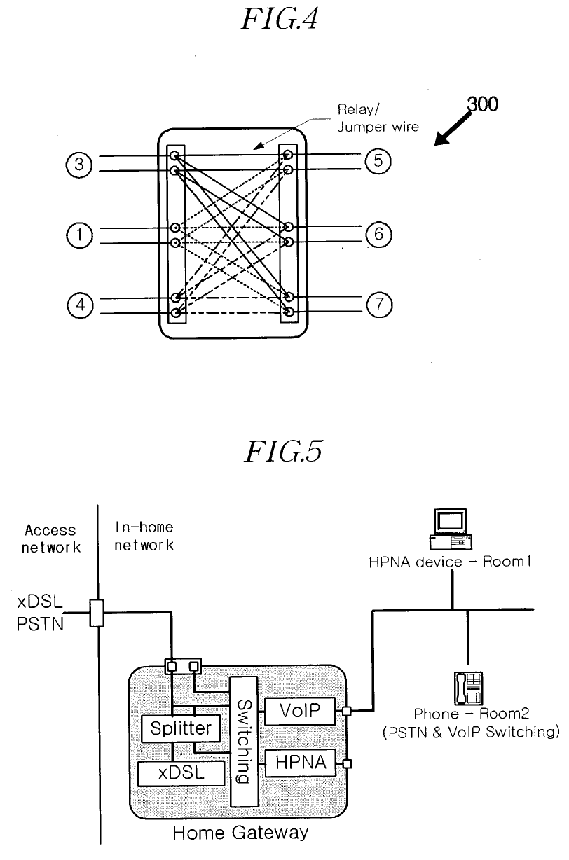

FIG. 5 is a schematic of a split-type two-wire in-home network using the home gateway apparatus in accordance with a first embodiment of the present invention.

Referring to FIG. 5, the home gateway apparatus according to the first embodiment provides access to an external access network having both xDSL and PSTN signals, and to an in-home telephone network with VoIP and PSTN telephones connected to a HomePNA device.

More specifically, the home gateway apparatus separates external access network channels connected to signal line (1) using the high-pass filter 309 and the low-pass filter 310. The PSTN signal is forwarded to the in-home network with low-pass filtered signal line (4) connected to signal line (6), and the HomePNA signal is connected to the in-home HomePNA network with signal line (5) connected to signal line (7).

In the home gateway apparatus, the VoIP function can be used alternatively with the PSTN function using a general in-home telephone. If the user wants to use an existing PSTN telephone in the in-home network and connect the telephone to the home gateway for the VoIP function, the PSTN and HomePNA network can be constructed by connecting the signal line (4) to the signal line (7) and the in-home telephone network to the second connector RJ11 305 of the HomePNA processor 306. With the telephone connected to the third connector RJ11 307 of the VoIP central processor 304, and the signal line (4) connected to the signal line (6), a VoIP telephone with a general VoIP/PSTN switching function using ‘#’ or ‘*’ buttons can be separately used.

FIG. 6 is a schematic of a non-split type two-wire in-home network using the home gateway apparatus in accordance with a second embodiment of the present invention.

Referring to FIG. 6, the home gateway apparatus 100 according to the second embodiment includes an external access network having both XDSL and PSTN signals, and an in-home telephone network having a HomePNA device directly connected to a PSTN telephone.

More specifically, the home gateway apparatus 100 separates the access network channel connected to signal line (1) through the high-pass filter 309 and the low-pass filter 310, and a PSTN telephone can be used irrespective of the home gateway.

With signal line (4) connected to signal line (7) as shown in FIG. 5, the HomePNA signal in the home gateway is subjected to low-pass filtering by the low-pass filter 310 and thereby cannot be connected to the HomePNA device in the in-home network. So, the HomePNA signal is connected to the in-home HomePNA network with the signal line (1) connected to the signal line (7). In this case, the VDSL service is unavailable because the HomePNA and xDSL signals are connected to the same signal line. For the VoIP function, a separate VoIP telephone with a general VoIP/PSTN switching function using ‘#’ or ‘*’ buttons can be used with the telephone connected directly to the home gateway and the signal line (4) connected to the signal line (6).

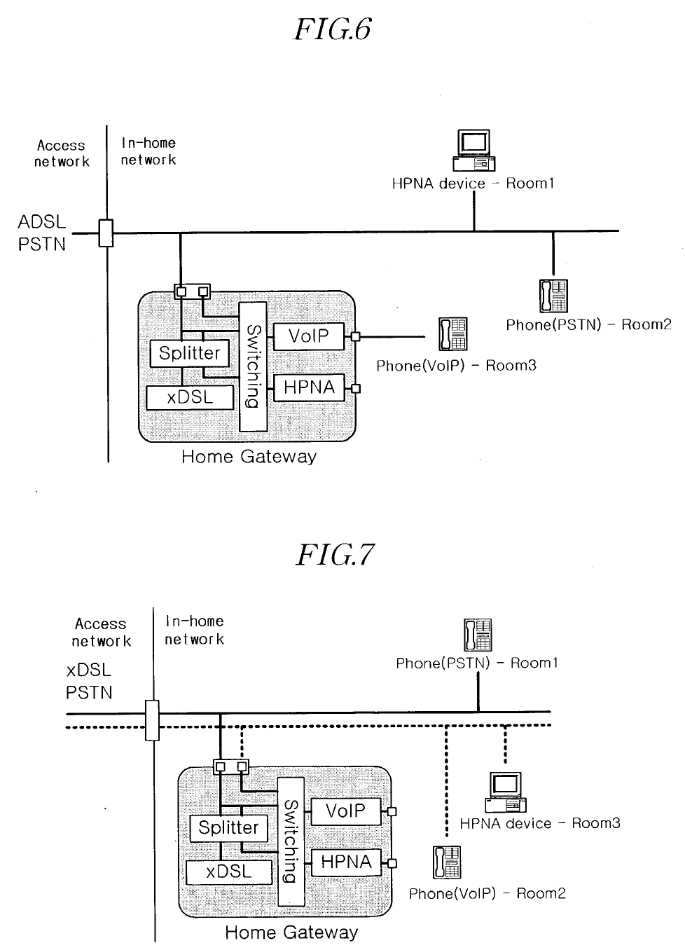

FIG. 7 is a schematic of a four-wire in-home network of a single xDSL/PSTN structure using the home gateway apparatus in accordance with a third embodiment of the present invention.

Referring to FIG. 7, the home gateway apparatus according to the third embodiment includes an external access network having both xDSL and PSTN signals, and an in-home telephone network directly connected to a PSTN telephone.

The other two wires are connected to a HomePNA device and a VoIP telephone, and VDSL and HomePNA can be used at the same time because the channels used for the VDSL and the HomePNA are separated from each other. The high-pass filter 309 and the low-pass filter 310 separate xDSL/PSTN channels connected to signal line (1), and the PSTN telephone can be used irrespective of the home gateway.

The HomePNA channel is connected to the in-home HomePNA network with signal line (3) connected to signal line (7), and the VoIP channel is connected to the in-home VoIP network with signal line (3) connected to signal line (5). The switching from VoIP to PSTN is realized with signal line (4) connected to signal line (6).

If switching the VoIP telephone to PSTN, the signal lines (3), (4), (5), (6) and (7) are all connected but the HomePNA signal is separated from the xDSL signal through the low-pass filter 310. Power supply to the in-home PSTN telephone is externally provided for normal operation.

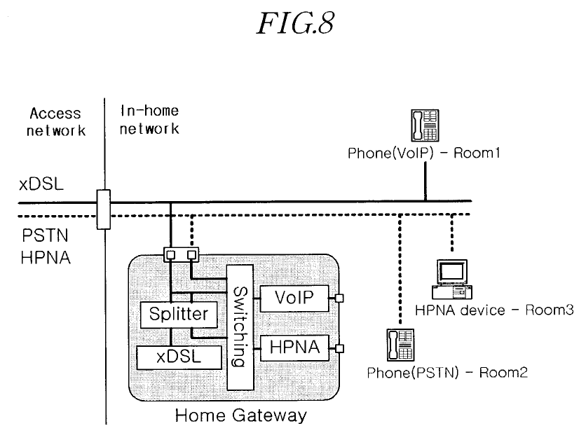

FIG. 8 is a schematic of an xDSL/PSTN split-type four-wire in-home network using the home gateway apparatus in accordance with a fourth embodiment of the present invention.

Referring to FIG. 8, the home gateway apparatus according to the fourth embodiment includes, unlike the third embodiment, an external access network having xDSL and PSTN signals connected to two different wires. But this structure is also similar to that of the third embodiment in that the channels used for xDSL and HomePNA are separated from each other to enable the use of VDSL and HomePNA at the same time.

Namely, the high-pass filter 309 and the low-pass filter 310 separate the xDSL channel connected to signal line (1), and the PSTN telephone connected to signal line (3) can be used irrespective of the home gateway.

The HomePNA channel is connected to the in-home HomePNA network with signal line (3) connected to signal line (7), and the VoIP channel is connected to the in-home VoIP network with signal line (4) connected to signal line (5). The switching from VoIP to PSTN is realized with signal line (3) connected to signal line (6).

The HomePNA signal is separated from the XDSL signal through the low-pass filter 310, and power supply to the in-home PSTN telephone is externally provided for a normal operation.

In this manner, the home gateway apparatus having an in-home telephone network switching function and its embodiment method according to the embodiment of the present invention include an access network connector to provide xDSL access capable of four-wire access, and an in-home network connector to provide a single VoIP access and high-speed HomePNA access; and changes the internal connection structure of the home gateway according to the construction of the in-home network using the in-home telephone network switching function, thereby allowing easy construction of in-home VoIP/POTS and high-speed HomePNA networks by a single home gateway only without regard to the existing two-wire or four-wire in-home telephone line.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the home gateway apparatus having an in-home telephone network switching function and its embodiment method according to present invention includes an access network connector to provide xDSL access capable of four-wire access, and an in-home network connector for providing single VoIP access and high-speed HomePNA access; and changes the internal connection structure of the home gateway according to the construction of the in-home network using the in-home telephone network switching function, thereby allowing easy construction of in-home VoIP/POTS and high-speed HomePNA networks by a single home gateway only without regard to the existing two-wire or four-wire in-home telephone line.

The home gateway apparatus having an in-home telephone network switching function and its embodiment method according to present invention enables the use of a VoIP function while using the existing POTS network at home, and provides both voice call and HomePNA functions using a single connector, and the VoIP functions freely in the in-home network using a single four-wire XDSL connector without connecting a telephone to the home gateway.

The home gateway apparatus having an in-home telephone network switching function and its embodiment method according to the present invention uses the existing in-home and outdoor telephone lines with an advantage in the aspect of economy, and it enables construction of the in-home network simply by changing the internal setting of the home gateway without replacement of the home gateway even when the structure of the in-home telephone network is changed.

The home gateway apparatus having an in-home telephone network switching function and its embodiment method according to the present invention offers xDSL-based ultrahigh-speed broadband services between a variety of data terminals connected to the in-home network through different network interfaces such as HomePNA, IEEE1394, high-speed Ethernet, or wireless LAN, and delivers ultrahigh-speed broadband services of more than 10 Mbps in gaining access to the access network from the in-home network.

The home gateway apparatus having an in-home telephone network switching function and its embodiment method according to the present invention uses the same physical connector for XDSL, HomePNA, and VoIP signals, and it offers a HomePNA function as well as xDSL and VoIP/POTS functions using a single connector, thereby simplifying the installation of the home gateway.

Furthermore, the home gateway apparatus having an in-home telephone network switching function and its embodiment method according to the present invention provides the HomePNA function by a connection to the in-home POTS network while VoIP or POTS is not being used, and it provides the HomePNA function by a connection of the in-home POTS network to the HomePNA connector when the VoIP function is solely used by a general telephone without a connection to the VoIP/POTS network.

What is claimed is:

1. A home gateway apparatus, which provides a connection of an in-home network to an access network to offer a variety of services in an integrated network, the home gateway apparatus comprising:
an XDSL (“x” variety of Digital Subscriber Line) central processor for providing access to the access network through a first connector, and processing a signal communicated with the connected access network;
a HomePNA (Home Phoneline Networking Alliance) processor for providing HomePNA access to the in-home network through the first connector, and processing a HomePNA signal communicated with the connected in-home network;
a VoIP (Voice over Internet Protocol) processor for providing POTS (Plain Old Telephone Service)/VoIP access to the in-home network through the first connector, and processing a POTS/VoIP signal communicated with the connected in-home network; and
a telephone line switching processor for connecting at least one PSTN (Public Switching Telephone Network) channel transferred from the XDSL central processor to the HomePNA processor and the VoIP processor.

2. The home gateway apparatus as claimed in claim 1, wherein the xDSL central processor provides access to a two-wire and four-wire access networks.

3. The home gateway apparatus as claimed in claim 2, wherein the XDSL central processor uses high-pass and low-pass filters to separate XDSL and PSTN signals received from the connected two-wire and four-wire access networks, and sends the separated signals to an xDSL auxiliary processor and the telephone line switching processor.

4. The home gateway apparatus as claimed in claim 2, wherein the telephone line switching processor is connected using a medium according to a change of the connected in-home network, and is changeable in setting by a user's simple manipulation of switches.

5. The home gateway apparatus as claimed in claim 4, wherein the medium includes a relay and a jumper wire.

6. The home gateway apparatus as claimed in claim 1, wherein the HomePNA processor and the VoIP processor are connected to the in-home network using second and third connectors.

7. An embodiment method for a home gateway apparatus, which provides a connection of an in-home network to an access network to offer a variety of services in an integrated network, the embodiment method comprising:
(a) providing access to a two-wire and four-wire access networks through a first connector, and processing a signal communicated with the connected access network;
(b) providing HomePNA access to the in-home network through the first connector, and processing a HomePNA signal communicated with the connected in-home network;
(c) providing POTS/VoIP access to the in-home network through the first connector, and processing a POTS/VoIP signal communicated with the connected in-home network; and
(d) connecting at least one PSTN channel transferred from the connected access network to a HomePNA processor processing the HomePNA signal and a VoIP processor processing the POTS/VoIP signal communicated with the connected in-home network.

8. The embodiment method as claimed in claim 7, wherein (a) comprises:
separating XDSL and PSTN signals received from the connected two-wire and four-wire access networks using high-pass and low-pass filters.

9. The embodiment method as claimed in claim 7, wherein (b) and (c) comprise:
providing access to the in-home network using second and third connectors.

10. The embodiment method as claimed in claim 7, wherein (d) comprises:
providing a connection using a medium including a relay and a jumper wire according to a change of the connected in-home network; and
allowing a user to change the setting by a simple manipulation of switches.

11. A recording medium with a built-in program, which includes an embodiment method for a home gateway apparatus providing a connection of an in-home network to an access network to offer a variety of services in an integrated network, the program comprising:
providing access to the access network through a first connector, and processing a signal communicated with the connected access network;
providing HomePNA access to the in-home network through the first connector, and processing a HomePNA signal communicated with the connected in-home network;
providing POTS/VoIP access to the in-home network through the first connector, and processing a POTS/VoIP signal communicated with the connected in-home network; and
connecting at least one PSTN channel transferred from the connected access network to a HomePNA processor processing the HomePNA signal and a VoIP processor processing the POTS/VoIP signal communicated with the connected in-home network.
